(19) United States
(12) Patent Application Publication
(10) Pub. No.: US 2025/0027835 A1
(43) Pub. Date: Jan. 23, 2025

(54) LOW-COST ROBOTIC SHAKE TABLE AND METHOD FOR OPERATING THE SAME

(71) Applicants: ARIZONA BOARD OF REGENTS ON BEHALF OF ARIZONA STATE UNIVERSITY, Scottsdale, AZ (US); UNIVERSITY OF NEBRASKA-LINCOLN, Lincoln, NE (US)

(72) Inventors: Jnaneshwar Das, Tempe, AZ (US); Zhiang Chen, Pasadena, CA (US); Devin Keating, Tempe, AZ (US); Yash Shethwala, Tempe, AZ (US); Aravind Saravanakumaran, Tempe, AZ (US); J. Ramón Arrowsmith, Tempe, AZ (US); Christine Wittich, Lincoln, NE (US)

(21) Appl. No.: 18/778,748

(22) Filed: Jul. 19, 2024

Related U.S. Application Data
(60) Provisional application No. 63/514,793, filed on Jul. 20, 2023.

(51) Int. Cl. G01M 7/02

(52) U.S. Cl. CPC G01M 7/022; G01M 7/025

(57) ABSTRACT

A low-cost robotic shake table and method for operating the same is disclosed. The shake table includes a chassis having a pedestal slidably coupled to two linear shafts. The shake table also includes a motion system having a stepper motor, a transmission, and a motor driver, with the stepper motor coupled to the pedestal through the transmission. The shake table includes a perception system having a camera, an accelerometer coupled to the pedestal, and a plurality of fiducial markers coupled to the pedestal, and a microcontroller communicatively coupled to the motor driver and the perception system. The microcontroller is configured to receive an input motion data, produce a set of translational velocities based upon the input motion data, and convert the set of translational velocities into a control signal that will cause the stepper motor to move the pedestal along the linear shafts according to the translational velocities.

### RELATED APPLICATIONS

This application claims the benefit of U.S. provisional patent application 63/514,793 filed Jul. 20, 2023 titled “A Low-Cost Robotic Shake Table,” the entirety of the disclosure of which is hereby incorporated by this reference.

### TECHNICAL FIELD

Aspects of this document relate generally to shake tables.

### BACKGROUND

For decades, researchers have used shake tables to simulate the effects of earthquakes on structures, systems, and materials, providing a critical approach to earthquake research and education. Simulated earthquake conditions can help civil engineers identify potential weaknesses in the design and suggest ways to improve a structure's resilience. In a controlled laboratory setting, shake tables can also be used to study the behavior of fragile geological features, which aids seismologists in finding upper-bound constraints on ground motions. By simulating earthquakes in the classroom, students can better understand the forces involved and the factors that influence the behavior of structures, inspiring the next generation of engineers and seismologists.

Full-or large-scale shake tables and tabletop shake tables have specific applications in research and education. Full-scale shake tables are designed to simulate earthquakes on full-scale buildings, bridges, and other large structures. Full-scale shake tables, which usually incorporate acceleration and displacement sensors for ground motion estimations, are expensive to build and maintain. The high cost limits their availability in research and education. Full-scale shake tables may also involve safety considerations in operation and damage prevention.

Tabletop shake tables, on the other hand, are typically used to test smaller models and structure components. Because of their low cost, these tables are also useful in educational settings to teach students about the behavior of structures under earthquake conditions. However, tabletop shake tables have downsides as well. Many of these shake tables are either prohibitively expensive for their intended purpose, or are limited in their functionality (e.g., only allowing a fixed ground motion pattern, etc.) Conventional tabletop shake tables operate on proprietary hardware, and many use proprietary software as well. Additionally, these small-scale shake tables solely employ accelerometers to measure ground motions.

An important application of shake tables is to examine the dynamics of precariously balanced rocks (PBRs), which are free-standing rocks balanced on, but not attached to, sub-horizontal pedestals. Because an earthquake ground motion of sufficient amplitude and duration may topple PBRs, the fragile configurations of PBRs provide upper-bound constraints on ground motions, refining probabilistic seismic hazard analysis. The dynamics of the PBR overturning process are non-linear. However, difficulties can arise when using conventional shake tables to repeat overturning experiments. For example, when analyzing PBR fragility, shake experiments would involve accurate and repeated positioning of a large boulder on the shake table to record the overturning responses given ground motions. These boulders are often so heavy that the use of a crane or forklift is needed. and repositioning them precisely is difficult, complicating experiment repeatability.

### SUMMARY

According to one aspect, a method for operating a robotic shake table, includes receiving a specimen placed on top of a pedestal, the pedestal slidably coupled to two linear shafts of a chassis, and receiving an input motion data at a microcontroller. The microcontroller is communicatively coupled to a motion system and a perception system. The motion system includes a stepper motor, a transmission, and a motor driver communicatively coupled to a stepper motor, with the stepper motor coupled to the pedestal through the transmission, with the stepper motor also fixedly coupled to the chassis. The perception system includes at least one of an accelerometer coupled to the pedestal and a camera positioned above the pedestal to view a plurality of fiducial markers affixed to the pedestal. The method also includes producing a set of translational velocities based upon the input motion data, and converting the set of translational velocities into a control signal for the motor driver. The method further includes driving the stepper motor according to the control signal to move the pedestal along the two linear shafts while the specimen is on top of the pedestal and while recording perception data from the perception system, and estimating a ground motion velocity of the pedestal using the perception data obtained from the perception system.

Particular embodiments may comprise one or more of the following features. The input motion data may include a peak ground acceleration and a peak ground velocity. Producing the set of translational velocities based upon the input motion data may include defining a ground velocity function derived from a single-pulse cosine displacement function that may include the peak ground acceleration and the peak ground velocity, and producing the set of translational velocities by evaluating the ground velocity function at different times. The input motion data may include a seismometer record having raw acceleration data. Producing the set of translational velocities based upon the input motion data may include removing high-frequency noise from the raw acceleration data using a low-pass filter, numerically integrating the raw acceleration data to obtain velocity data, and/or producing the set of translational velocities by removing low-frequency noise from the velocity data using a high-pass filter. Estimating the ground motion velocity of the pedestal using the perception data obtained from the perception system may include at least one of measuring ground motion accelerations of the pedestal using perception data from the accelerometer and estimating ground motion displacements of the pedestal using perception data from the camera observing the plurality of fiducial markers. Measuring ground motion accelerations of the pedestal using perception data from the accelerometer may include obtaining raw acceleration data from the accelerometer, applying a low-pass filter to the raw acceleration data, and/or calculating the absolute value of an acceleration vector defined by the raw acceleration data. Estimating the ground motion velocity may include numerically integrating the ground motion acceleration. Estimating ground motion displacements of the pedestal using the perception data from the camera observing the plurality of fiducial markers may include averaging a relative displacement of each fiducial marker of the plurality of fiducial markers that may be visible to the camera. Estimating the ground motion velocity may include numerically differentiating the ground motion displacements. Estimating ground motion velocity of the pedestal may include combining ground motion velocities estimated using ground motion accelerations obtained using perception data from the accelerometer with ground motion velocities estimated using ground motion displacements estimated using perception data from the camera, forming a combined set of ground motion velocities. Estimating ground motion velocity of the pedestal may include minimizing an error between the combined set of ground motion velocities based on perception data and an estimated velocity function by applying a regression model. The estimated velocity function may be a polynomial function. The ground motion velocities estimated from the ground motion accelerations and the ground motion velocities estimated using the ground motion displacements may be asynchronously aligned. The perception system further may include an encoder, and the perception system and the motion system operate together in a closed loop. The specimen may be a model of a precariously balanced rock. The method may further include recording an overturn response describing the specimen after the specimen has stopped moving.

According to another aspect of the disclosure, a robotic shake table includes a chassis having two linear shafts and a pedestal slidably coupled to the two linear shafts, and a motion system including a stepper motor, a transmission, and a motor driver communicatively coupled to the stepper motor, with the stepper motor coupled to the pedestal through the transmission and the stepper motor also fixedly coupled to the chassis. The robotic shake table includes a perception system having a camera, an accelerometer coupled to the pedestal, and a plurality of fiducial markers coupled to the pedestal. The robotic shake table also includes a microcontroller communicatively coupled to the motor driver and the perception system, the microcontroller including a processor and a memory, with the processor configured to receive an input motion data, produce a set of translational velocities based upon the input motion data, and convert the set of translational velocities into a control signal that will cause the stepper motor to move the pedestal along the two linear shafts according to the set of translational velocities when the control signal is sent to the motor driver.

Particular embodiments may comprise one or more of the following features. The processor may be further configured to receive perception data from the perception system. The perception data may include raw acceleration data from the accelerometer and relative displacements of fiducial markers observed by the camera. The raw acceleration data and the relative displacements may be asynchronously aligned. The perception system further may include an encoder. The motion system may be a closed loop. The input motion data may include a seismometer record having raw acceleration data. The processor may produce the set of translational velocities based upon the input motion data by removing high-frequency noise from the raw acceleration data using a low-pass filter, numerically integrating the raw acceleration data to obtain velocity data, and producing the set of translational velocities by removing low-frequency noise from the velocity data using a high-pass filter. The input motion data may include a peak ground acceleration and a peak ground velocity. The processor may produce the set of translational velocities based upon the input motion data by defining a ground velocity function derived from a single-pulse cosine displacement function that may include the peak ground acceleration and the peak ground velocity, producing the set of translational velocities by evaluating the ground velocity function at different times.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIGS. 1A and 1B are perspective and top views of a robotic shake table;

FIG. 2 is a schematic view of a robotic shake table;

FIG. 3 is a process view of a method for observing motion in a robotic shake table;

FIG. 4 is a process view of a method for controlling motion in a robotic shake table;

FIGS. 5A and 5B are photographs of a precariously balanced rock (PBR) at the Double Rock site in California;

FIGS. 6A and 6B are overturning response diagrams of the Double Rock PBR from orientations of yaw 0° and yaw 270°, respectively;

FIG. 7 shows overturning boundary curves obtained from both real and virtual robotic shake tables;

FIG. 8 shows estimation results of acceleration, displacement, and velocity for the Double Rock PBR; and

FIG. 9 is a process flow of a method for operating a robotic shake table.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

For decades, researchers have used shake tables to simulate the effects of earthquakes on structures, systems, and materials, providing a critical approach to earthquake research and education. Simulated earthquake conditions can help civil engineers identify potential weaknesses in the design and suggest ways to improve a structure's resilience. In a controlled laboratory setting, shake tables can also be used to study the behavior of fragile geological features, which aids seismologists in finding upper-bound constraints on ground motions. By simulating earthquakes in the classroom, students can better understand the forces involved and the factors that influence the behavior of structures, inspiring the next generation of engineers and seismologists.

Full- or large-scale shake tables and tabletop shake tables have specific applications in research and education. Full-scale shake tables are designed to simulate earthquakes on full-scale buildings, bridges, and other large structures. Full-scale shake tables, which usually incorporate acceleration and displacement sensors for ground motion estimations, are expensive to build and maintain. The high cost limits their availability in research and education. Full-scale shake tables may also involve safety considerations in operation and damage prevention.

Tabletop shake tables, on the other hand, are typically used to test smaller models and structure components. Because of their low cost, these tables are also useful in educational settings to teach students about the behavior of structures under earthquake conditions. However, tabletop shake tables have downsides as well. Many of these shake tables are either prohibitively expensive for their intended purpose, or are limited in their functionality (e.g., only allowing a fixed ground motion pattern, etc.) Conventional tabletop shake tables operate on proprietary hardware, and many use proprietary software as well. Additionally, these small-scale shake tables solely employ accelerometers to measure ground motions.

An important application of shake tables is to examine the dynamics of precariously balanced rocks (PBRs), which are free-standing rocks balanced on, but not attached to, sub-horizontal pedestals. Because an earthquake ground motion of sufficient amplitude and duration may topple PBRs, the fragile configurations of PBRs provide upper-bound constraints on ground motions, refining probabilistic seismic hazard analysis. The dynamics of the PBR overturning process are non-linear. However, difficulties can arise when using conventional shake tables to repeat overturning experiments. For example, when analyzing PBR fragility, shake experiments require accurate and repeated positioning of a large boulder on the shake table to record the overturning responses given ground motions. These boulders are often so heavy that the use of a crane or forklift is needed, and repositioning them precisely is difficult, complicating experiment repeatability.

Contemplated herein is a low-cost robotic shake table for earthquake engineering research and education. The contemplated robotic shake table (also referred to as the Shakebot), makes use of a simplified design, where most of the mechanical parts and components are off-the-shelf, and the remaining unique parts can be 3D-printed. This simplified design lowers costs and expedites prototyping.

Shakebot employs a closed-loop stepper motor for actuation and a toothed belt for transmission, according to various embodiments. Additionally, some embodiments of the contemplated robotic shake table comprise a double emergency mechanism to allow system override in case of malfunction. The low cost, ease of use, and safety features make the Shakebot accessible to a wide range of users, including students, educators, and researchers in low-resource settings.

According to various embodiments, the Shakebot is equipped with a “perception system” that includes an accelerometer and a high frame-rate camera for carriage motion estimation. Advantageous over traditional tabletop shake tables that only use accelerometers, the contemplated robotic shake table leverages a top-down view camera to estimate ground motion. Some embodiments of the perception system provide an option of fusing ground velocity estimations made using accelerometer-and camera-based measurements, yielding a more accurate account of the motion observed than would otherwise be possible using a conventional shake table.

The contemplated robotic shake table is the first tabletop shake table developed using robotic concepts (e.g., perception systems, motion systems, etc.) and tools (e.g., Robot Operating System or ROS). The use of concepts and technology borrowed from robotics advantageously allows the Shakebot to provide a reverse method for simulation validation. Physics simulation engines have been used for robotic development. However, when robotic systems are transitioned from simulation to the real world, simulation gaps may cause critical failures (e.g., in the arena of reinforcement learning, etc.). When using a physics engine for scientific studies, the simulation gap to calibrate and scale-up the simulation experiments also needs to be addressed.

Simulation can be a valuable research tool. However, research performed using simulation needs to be validated. Simulations have been performed using ROS as a foundation for the movement of a virtual shake table. The contemplated robotic shake table provides an approach to validate those simulations through physical experiments. According to various embodiments, the ROS-based perception and motion software used facilitates the code transition from the virtual Shakebot to the physical Shakebot. The reuse of the control programs ensures that the implemented ground motions are consistent for both the simulation and physical experiments, which is critical to validate the simulation experiments.

The contemplated robotic shake table has a number of applications. As a specific, non-limiting example, the Shakebot has been used to investigate the dynamics of precariously balanced rocks (PBRs). Using the Shakebot, the overturning dynamics of down-scaled, 3D-printed PBRs have been tested. The same PBR models were built in a ROS-based simulation, where the overturning dynamics were investigated using the virtual shake robot. Following this approach, a comparison between the overturning patterns obtained from the Shakebot and the virtual shake table can be made, making it possible to quantify the uncertainty in simulation. According to various embodiments, the Shakebot can serve as a validation tool for simulation studies, aiding in learning more about the real-time dynamics of the PBRs and potentially calibrating physics engine parameters to reduce the simulation gaps.

It should be noted that while various examples of the Shakebot will be discussed in the context of PBR dynamics, the Shakebot may be used in other investigations making use of shake tables. The contemplated robotic shake table provides an affordable and accessible platform for other earthquake research and education, and should not be interpreted as being limited to PBR studies.

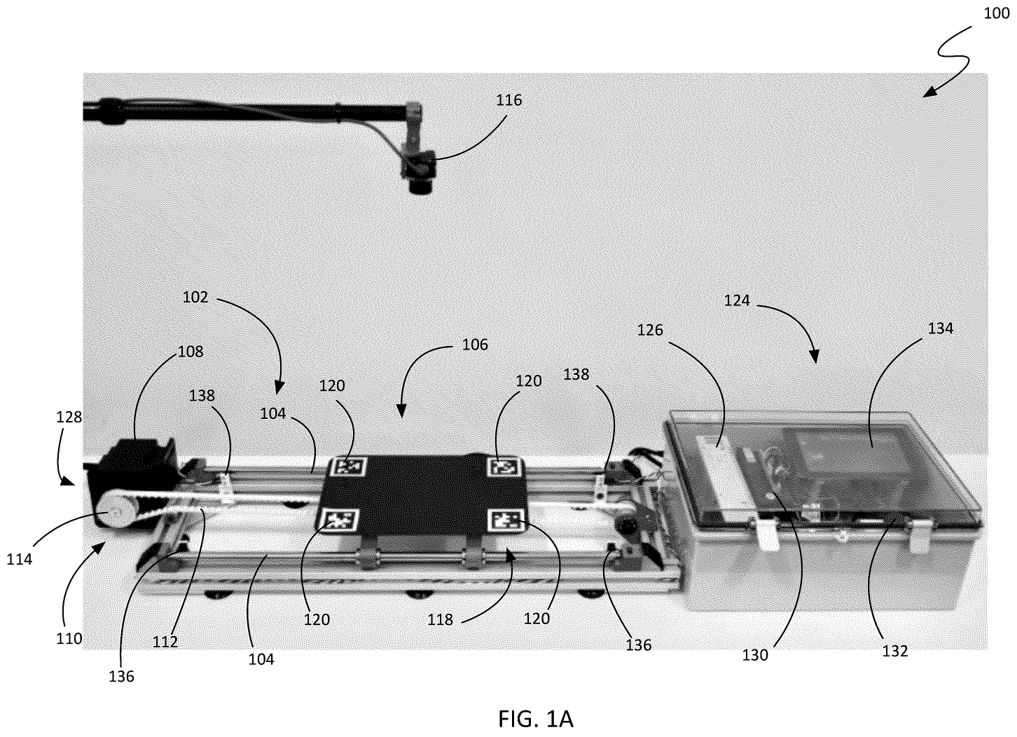

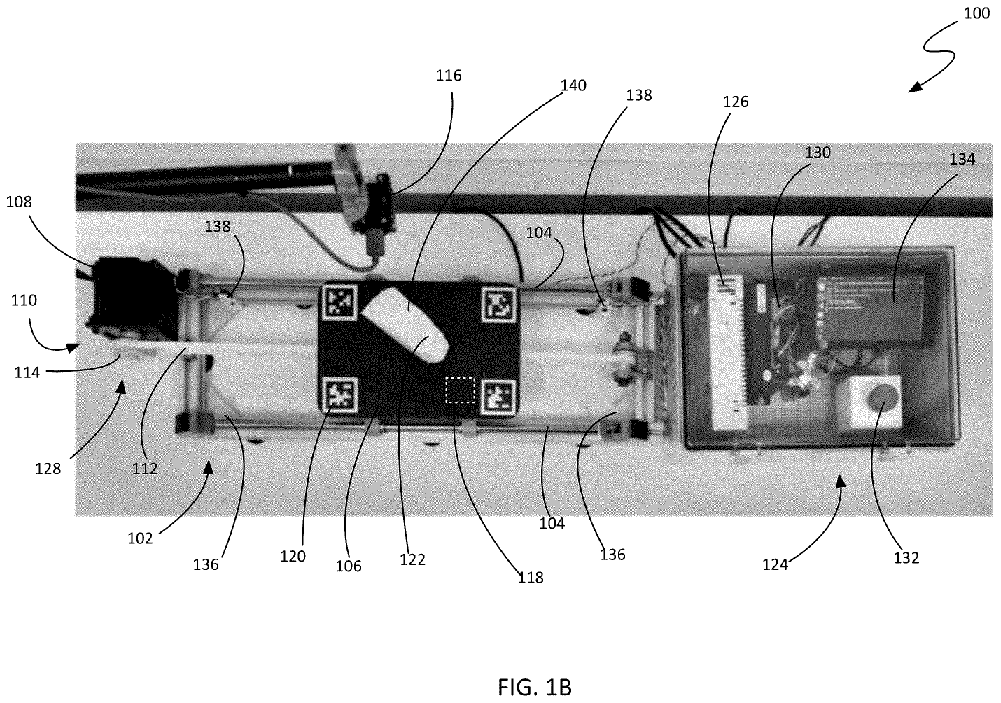

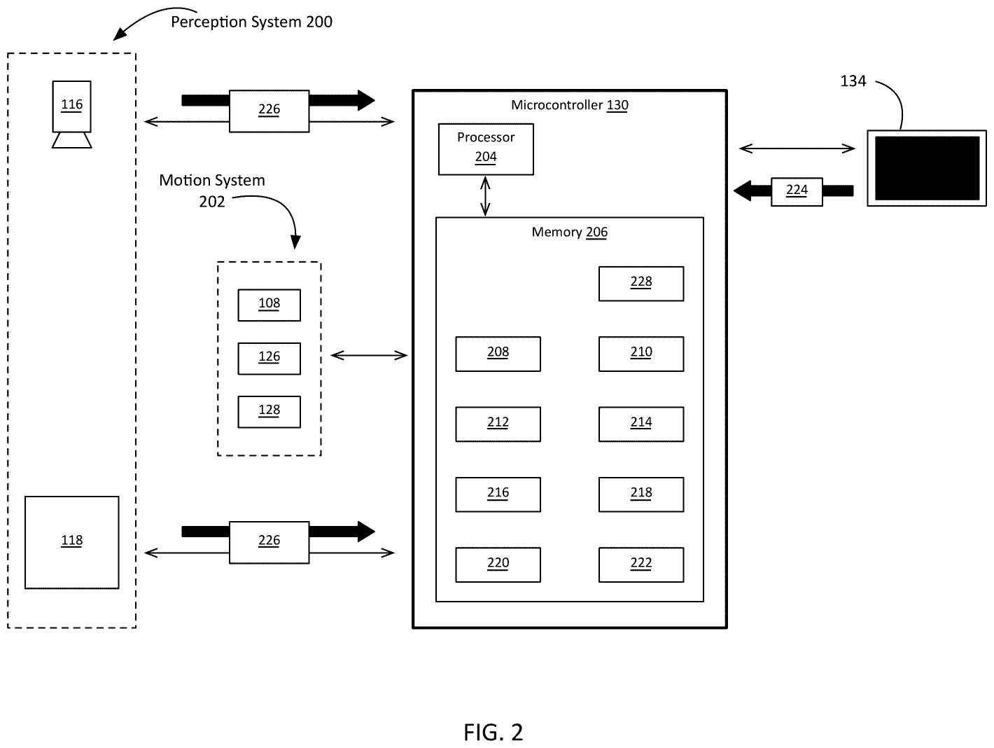

FIGS. 1A and 1B are perspective and top views of a non-limiting example of a robotic shake table, respectively. FIG. 2 is a schematic view of a Shakebot, focused on the electrical connectivity within the shake table. As shown, the Shakebot 100 comprises a chassis 102 having a sliding pedestal 106 which is moved by a motion system 202 and observed by a perception system 200. Each will be discussed in detail, below.

According to various embodiments, the chassis 102 comprises at least two linear shafts 104. A pedestal 106 is slidably coupled to the linear shafts 104 such that it can slide back and forth along them. In some embodiments, the pedestal 106 is mounted on the linear shafts 104 using ball bearings, which reduce the friction between the linear shafts 104 and the pedestal 106. In other embodiments, other mountings or mechanisms known in the art may be used to slidably couple the pedestal 106 to the linear shafts 104 of the chassis 102.

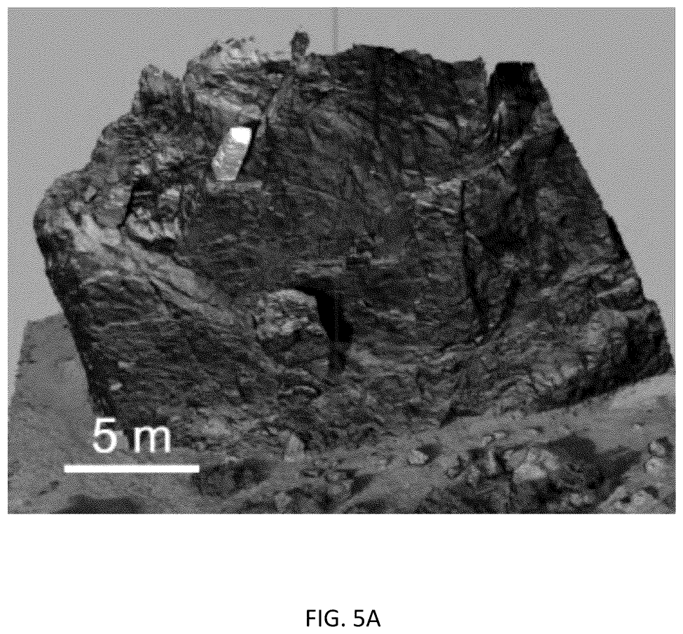

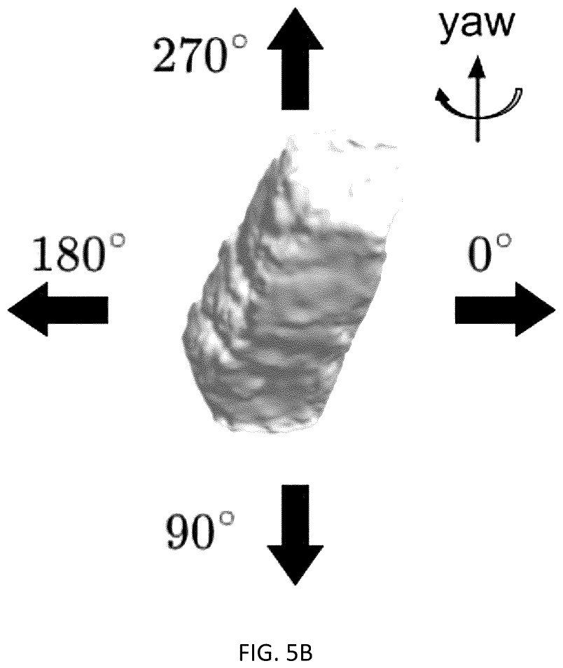

The pedestal 106 has a top surface for holding a specimen 122. In a specific, non-limiting example that will be discussed in the context of FIGS. 5-8, the specimen 122 may be a 3D-printed, scaled-down model of a precariously balanced rock 140 (or PBR 140).

The movement of the pedestal 106 is caused by and controlled through a motion system 202 comprising a stepper motor 108, a transmission 110, and a stepper motor driver 126 communicatively coupled to the stepper motor 108, according to various embodiments. The stepper motor 108 is fixedly coupled to the chassis 102, and actuates the pedestal 106 through the transmission 110 (i.e., the stepper motor 108 is coupled to the pedestal 106 through the transmission 110). According to various embodiments, the transmission 110 may be a toothed “belt and pulley” transmission, with a toothed pulley 114 engaged with a compatible belt 112. Other embodiments may employ different transmissions 110.

According to various embodiments, the stepper motor 108 may be selected by first considering the torque required such that, at maximum angular velocity, the needed ground motion acceleration and velocity for the intended use can be satisfied. Because stepper motor torque decreases with velocity, if the torque at the maximum velocity satisfies the acceleration requirement, the stepper motor 108 can also achieve so at smaller velocities.

As a specific, non-limiting example, the stepper motor 108 in one embodiment is the Nema 34HS31. The Nema 34HS31 is a closed-loop stepper motor 108 with an encoder 128, and has a torque output of 1.56 Nm at the maximum speed of 1200 RPM. The maximum translational force is calculated from the torque,

$$F = ma = \frac{τ}{r} \qquad ( 1 )$$

where F is the translational force, r is the outside radius of the toothed pulley 114, m is the maximum payload mass (including the pedestal 106 and specimen 122), a is the maximum translational acceleration, and τ is the stepper motor 108 torque. A toothed pulley 114 with an outside radius of 25.91 mm was selected. The translational force at the maximum speed is 60.21 N. Considering a maximum total payload mass m of 4 kg (including a 2 kg pedestal 106 and 2 kg specimen 122), the corresponding acceleration produced from the translational motion is 15.1 m/s2 (1.54 g). The ratio of the calculated acceleration to the required acceleration is 1.28, which is adequate empirically to compensate for the friction and energy losses in transmission 110. Additionally, at the maximum stepper motor 108 speed of 1200 RPM, the translational speed can reach 0.52 m/s, which satisfies the requirement for the intended use of this specific, non-limiting embodiment (i.e., PBR dynamics studies). The outside radius of the toothed pulley 114 was used for the calculations for the stepper motor 108 selection.

According to various embodiments, a calibration process may be used to determine the precise effect of this radius, for accurate control. In some embodiments, this calibration process may be performed using a camera 116 and several fiducial markers 120. Calibration will be discussed in greater detail, below.

The stepper motor 108 is controlled by the motor driver 126. In some embodiments, the motion system 202 may also include an encoder 128, and may be a closed-loop system. In such a system, the stepper motor driver 126 reads signals from an encoder 128 attached to the stepper motor 108, forming a closed-loop system to control the stepper motor 108. In some embodiments, the microstepping technology in the stepper motor driver 126 allows a high step resolution (e.g., 1.8°/2000 per step), which achieves smooth motions at low speeds (e.g., as low as 0.001 m/s in the specific embodiment). In some embodiments, the closed-loop system may also incorporate signals received from the perception system 200, while in others the closed-loop may be confined to the motion system 202.

According to various embodiments, the contemplated robotic shake table 100 may comprise one or more safety features. In some embodiments, the safety features may comprise of a pair of limit emergency switches 136 situated at either end of the pedestal's range of motion on the linear shafts 104. These limit emergency switches 136 link to an emergency stop function on the stepper motor driver 126. Once either limit emergency switch 136 is triggered, the stepper motor 108 is disabled.

In other embodiments, the safety features may comprise an emergency stop button 132, which disconnects the power supply from the stepper motor driver 126. The emergency stop button 132 can be manually activated by the shake table's operator. In still other embodiments, including the non-limiting example shown in FIGS. 1A and 1B, both of these safety features may be implemented, as shown. The safety features may also include any other safety mechanisms known in the art, according to various embodiments.

As previously mentioned, the contemplated robotic shake table 100 comprises a perception system 200 made up of an accelerometer 118, a camera 116, and fiducial markers 120. The perception system 200 estimates the status of the pedestal 106 (on which the test subject is placed) using a camera 116 and an accelerometer 118. According to various embodiments, a plurality of fiducial markers 120 are affixed to the pedestal 106 (e.g., a fiducial marker 120 at each corner of the pedestal 106, etc.). A top-down view camera 116 (e.g., FLIR Chameleon®3 Color Camera CM3-U3-13Y3C-CS 1/2″, etc.) captures the position and orientation of the pedestal 106 using the ROS package apriltag_ros. Additionally, an accelerometer 118 (e.g., Wit Motion HWT905-TTL, etc.) attached underneath the pedestal 106 measures acceleration (i.e., ground motion acceleration). Ground motion displacement and ground motion acceleration are obtained directly or derived from the fiducial marker detection and accelerometer 118, respectively.

FIG. 2 is a schematic view of a non-limiting example of a robotic shake table 100 that focuses on the electrical connectivity among various elements. It should be noted that while FIG. 2 does not show any safety mechanisms (e.g., emergency stop button 132, limit emergency switch 136, etc.) or power supply, the omission was for simplification, and should not be interpreted as a limitation.

The contemplated robotic shake table 100 comprises a microcontroller 130 that handles trajectory generation and low-level system control. In some embodiments, the microcontroller 130 may also perform analysis of the data obtained. The microcontroller 130 comprises a processor 204 and a memory 206, and is configured to receive and handle inputs that may range from sensor output to user selections and instructions. As shown, the microcontroller 130 is communicatively coupled to the perception system 200, and may receive perception data 226 (e.g., raw accelerometer output, visual data, etc.) from the accelerometer 118 and the camera 116. The microcontroller 130 is also communicatively coupled to the motion system 202, and is able to provide a control signal to the motor driver 126 such that the pedestal 106 moves with the desired trajectory.

The microcontroller 130 is also configured to receive input from outside of the device. For example, some embodiments of the Shakebot 100 comprise a touchscreen 134 or some other human interface through which a user may provide instructions or experiment parameters. In some embodiments, a user may provide an overturn response 224 through the touchscreen 134 describing the specimen 122 after an experiment has been run and the specimen 122 has stopped moving, as will be discussed further, below. The microcontroller 130 is also able to receive data related to accelerations observed or simulated in real earthquakes, in some embodiments.

Some embodiments of the Shakebot 100 may comprise a touchscreen 134, while other embodiments may comprise other or additional avenues for information to be provided to the microcontroller 130 including, but not limited to, a network interface, a USB port, at the like.

According to various embodiments, the microcontroller 130 is configured to perform a number of tasks. In some embodiments, the ability to perform one or more of these tasks may be provided through software residing in the memory 206 of the microcontroller 130. In other embodiments, one or more of these tasks may be performed by a separate piece of hardware adapted for that particular function and with which the microcontroller 130 may communicate (e.g., ASIC, etc.). The non-limiting example shown in FIG. 2 depicts these tasks and routines as residing in the memory 206 of the microcontroller 130. Those skilled in the art will recognize that some or all of these may also be implemented in other hardware environments, even external environments such as a networked computer or similar resource.

As shown, the processor 204 is configured to provide a number of functionalities and perform a number of procedures. Examples include, but are not limited to, a low-pass filter 208 (i.e., to remove high-frequency noise), a high-pass filter 210 (i.e., to remove low-frequency noise), an integrator 212 (i.e., for numerical integration), differentiator 214 (i.e., for finding a numerical derivative), velocity controller 216 (i.e., to convert translation velocity into the angular velocity of the stepper motor), motion interpreter 218 (i.e., to convert peak ground acceleration and peak ground velocity into other parameters), trajectory planner 220 (i.e., to provide a ground velocity function), and the like.

In some embodiments, the microcontroller 130 may perform the needed operations to derive displacements from images of the fiducial markers 120 taken by the camera 116, using a vision system 228. As previously discussed, in some embodiments this may be facilitated through the Robot Operating System (e.g., the apriltag_ros package, etc.). In other embodiments, other methods or packages may be used by the microcontroller. In still other embodiments, the visually-derived displacement data may be provided by an external system, such as the camera 116 itself (e.g., onboard processing of the camera).

In some embodiments, the Shakebot 100 may comprise a control box 124 which may contain various components including, but not limited to, the stepper motor driver 126, a power supply, an emergency stop button 132, a touchscreen 134, and the microcontroller 130. In other embodiments, these components may be housed or otherwise incorporated into the shake table in other ways known in the art.

For illustrative purposes, a specific, non-limiting example of the contemplated Shakebot 100 will be described and discussed throughout, along with other embodiments. This specific embodiment should not be construed as a limitation nor meant to exclude other embodiments making use of different mechanisms, components, and materials, or directed to other shake table applications, beyond PBR dynamics. In this specific embodiment, the chassis 102 is constructed of an extruded aluminum T-slot frame that supports two linear shafts 104, each 625 mm in length. The stepper motor 108 (i.e., NEMA 34) is driven by the stepper motor driver 126 (i.e., CL86T) contained in a control box 124 that is 390×290×160 mm in size. The control box 124 also contains the power supply (i.e., S-350-60) and the microcontroller 130 (i.e., an off-the-shelf Raspberry Pi). This specific embodiment is able to provide a maximum dynamic acceleration of 11.8 m/s² (i.e., 1.2 g), a maximum velocity of 0.5 m/s, and a maximum displacement of 0.45 m, with a maximum specimen 122 payload mass of 2 kg. Again, other embodiments may use other components and have other capacities and abilities.

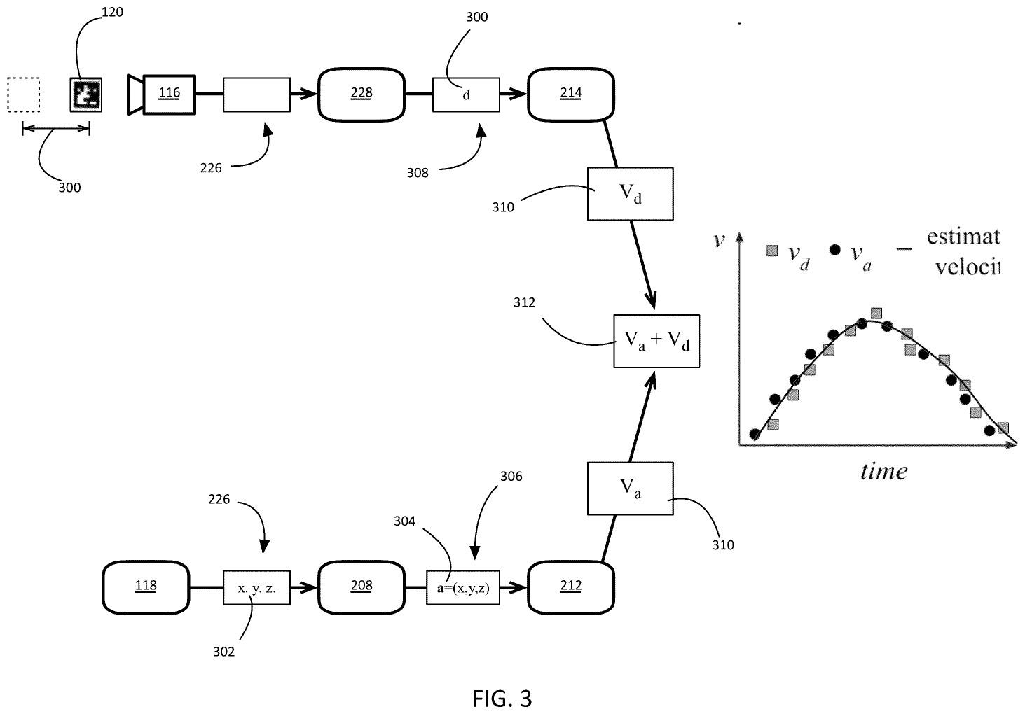

FIG. 3 is a process view of a non-limiting example of a method for estimating the ground motion velocity of the pedestal 106 in a robotic shake table 100 using perception data 226 obtained from the perception system 200. According to various embodiments, estimating the ground motion velocity 310 of the pedestal 106 using perception data 226 comprises at least one of: measuring ground motion accelerations 306 of the pedestal 106 using perception data 226 from the accelerometer 118; and estimating ground motion displacements 308 of the pedestal 106 using perception data 226 from the camera 116 observing the plurality of fiducial markers 120. From these displacements and/or accelerations, the ground motion velocity 310 may be estimated.

The camera 116 estimates ground motion displacement 308 by detecting the fiducial markers 120 on the pedestal 106 (e.g., at each corner of the pedestal 106). According to various embodiments, the apriltag_ros package provides the pose of each visible fiducial marker 120 in the camera coordinates. When the pedestal 106 moves from one position to another, the relative pose of a fiducial marker 120 attached to the pedestal 106 is obtained,

$${H}_{i}^{j} = {H}_{c}^{j} \cdot {H}_{i}^{c} = {[ {H}_{j}^{c} ]}^{- 1} \cdot {H}_{i}^{c} \qquad ( 2 )$$

where i and j indicate fiducial marker 120 positions at two time stamps, c indicates the camera coordinates, Hₐ^{b} is the transformation matrix for position a with respect to position b. Hⱼ^{c} and H_{c}ⁱ are obtained using the apriltag_ros package.

The translation vector is extracted from Hᵢ^{j} as the relative displacement 300 of the fiducial marker 120 at two positions. ground motion displacement 308 is estimated by averaging the relative displacements 300 from all visible fiducial marker 120 detections. When a fiducial marker 120 is obstructed by a specimen 122, the ground motion displacement 308 estimation relies upon the remaining visible fiducial markers 120. Because the relative displacement 300 from apriltag_ros is inaccurate, despite intrinsic camera calibration, additional perception calibration is performed. This calibration will be discussed in greater detail, below. Once the ground motion displacements 308 are obtained, they are numerically differentiated to yield an estimate of the ground motion velocities 310, according to various embodiments.

The accelerometer 118 installed beneath the pedestal 106 measures the ground motion acceleration 306 in three dimensions, provided as raw acceleration data 302. However, the pedestal's motion is limited to one degree-of-freedom prismatic movement. To obtain the acceleration along the pedestal 106 movement direction, the accelerometer's x-axis is aligned with the pedestal's direction of motion, according to various embodiments. However, because manual alignment is not perfect, the absolute value (i.e., Euclidean distance) of the acceleration vector 304 is also calculated, because the absolute acceleration value is the same value of the acceleration vector 304 along the pedestal 106 movement direction. To eliminate high-frequency vibration, a low-pass filter is applied to the raw acceleration data 302, according to various embodiments. Once the ground motion accelerations 306 have been obtained, they are numerically integrated to yield an estimate of the ground motion velocities 310, according to various embodiments.

According to various embodiments, the Shakebot 100 is also configured for estimation of the ground motion velocities 310 by fusing the velocities derived from the fiducial marker detection and the accelerometer 118 into a combined set of ground motion velocities 312. In some embodiments, velocities derived from these two sources may be considered separately. In other embodiments, the ground motion velocities 310 estimated using these two types of information may be fused together, yielding a more accurate account of the motion of the pedestal 106.

According to various embodiments, the combined set of ground motion velocities 312 may be used to yield an estimated ground motion velocity function, which is a regression of velocities from displacement and acceleration. During a shake experiment, the timestamped ground motion displacements 308 and accelerations are recorded. After the shake experiment, numerical derivation is implemented to obtain velocity v_{d}(t) from the ground motion displacements 308 d(t). From the ground motion accelerations 306, a(t), numerical integration is performed to obtain velocity vₐ(t).

From the recordings of fiducial markers 120 and accelerometer 118, two sets of derived velocities are obtained: v_{d}={v_{d}(t₁), . . . , v_{d}(t_{M})} and vₐ={vₐ(t₁), . . . , vₐ(t_{N})}. The ground motion velocity 310 estimation may be described as a regression problem with an objective function that minimizes the square of errors between estimated and derived velocities,

$$arg {min}_{θ} ‖ \hat{v} ( t ; θ ) - {v}_{s} ( t ) ‖ \qquad ( 3 )$$

where \hat{v}(t;θ) is an estimated, parametric ground motion velocity 310 function, and vₛ=v_{d}∪vₐ is a set of velocities derived from measurements. In some embodiments, the estimated velocity function may be a polynomial function. In other embodiments, different functions may be used.

In this ground motion velocity 310 estimation setting, {v_{d}(t)} and {vₐ(t)} need not be synchronized, simplifying the electronic hardware configuration of the contemplated Shakebot 100. The fiducial marker 120 detection and accelerometer 118 may have different frame rates. In other words, the raw acceleration data 302 and the relative displacements 300 are asynchronously aligned. Therefore, the ground motion velocities 310 estimated from the ground motion accelerations 306 and the ground motion velocities 310 estimated using the ground motion displacements 308 are asynchronously aligned.

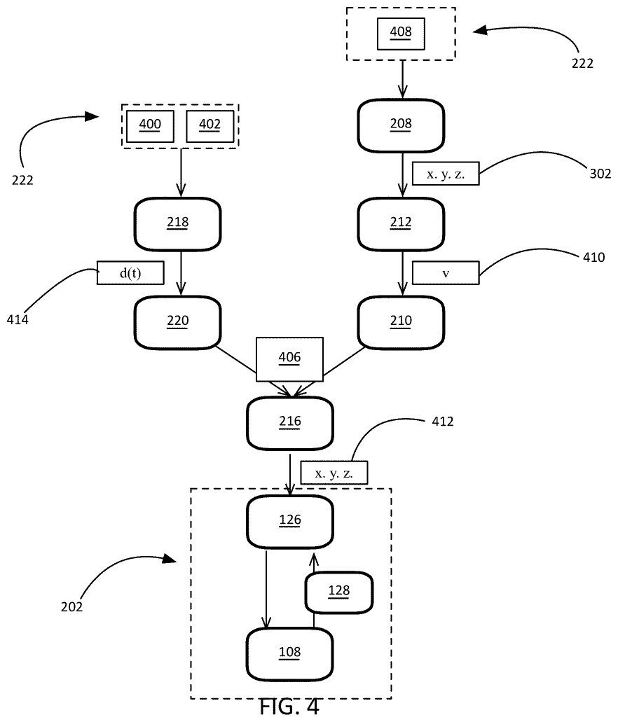

FIG. 4 is a schematic process view of a non-limiting example of a method for controlling motion in a robotic shake table 100. The Shakebot 100 is able to produce a set of translational velocities 406 (also called a trajectory) that describe how the pedestal 106 will move for a particular experiment. According to various embodiments, the Shakebot 100 produces there trajectories based on an input motion data 222 received by the microcontroller 130. In some embodiments, the Shakebot 100 is able to generate the set of translational velocities 406 based on different types of input motion data 222. Advantageously, in some embodiments, the format of the set of translational velocities 406 produced is independent of the method with which it was produced, making it easier to adapt to new forms of input motion data 222 and new generation procedures.

More specifically, FIG. 4 is a schematic process view of a non-limiting example of a hierarchical movement system that supports two types of ground motions and input motion data 222: single-pulse cosine displacement and realistic ground motion from seismogram acceleration recordings. Single-pulse cosine displacement is defined by peak ground velocity 402 (PGV) and peak ground acceleration 400 (PGA). According to various embodiments, the UI (e.g., touchscreen 134) assists users in repeating the shake experiment where single-pulse cosine displacement motions are deployed with different ground motion parameters.

The Shakebot 100 motion is enabled by a hierarchical movement planning system, composed of various modules and executed within the microcontroller 130 (e.g., Raspberry Pi, etc.), which outputs PWM control signals 412 to the closed-loop stepper motor driver 126. As shown in FIG. 4, the first ground motion option is a single-pulse cosine displacement 414,

$$d ( t ) = A - A cos ( 2 π f t ) \qquad ( 4 )$$

where d(t) is the ground displacement function, A is the amplitude, f is the frequency, and t∈[0,1/f] is time. A and f are derived from ground motion parameters,

$$f = \frac{1}{2 πκ} \qquad ( 5 )$$

$$A = \frac{α g}{4 {π}^{2} {f}^{2}} \qquad ( 6 )$$

where α is the peak ground acceleration 400 (PGA), κ is the ratio of peak ground velocity 402 to peak ground acceleration 400 (PGV/PGA), and g is the gravitational acceleration. The input motion data 222 comprises a peak ground acceleration 400 and a peak ground velocity 402. As shown in FIG. 4, the motion interpreter converts (PGV, PGA) to (A, f) using Eqs. 5-6. With (A, f), the trajectory planner takes derivative of the cosine displacement function (Eq. 4) to obtain ground velocity function 404,

$$v ( t ) = 2 π Af sin ( 2 π f t ) \qquad ( 7 )$$

where v(t) is the ground velocity function 404, and t∈[0,1/f] is time. From the ground velocity function 404, velocity points {v} are uniformly sampled as the input of the velocity controller. The sampling frequency is a user-defined parameter (e.g., 200 Hz, etc.). Note that the velocity commands {v} are desired translational velocities of the pedestal 106. The set of translational velocities 406 is generated by evaluating the ground velocity function 404 at different times.

The velocity controller converts the set of translational velocities 406 to angular velocities of the stepper motor 108,

$$ω ( t ) = \frac{v ( t )}{r} \qquad ( 8 )$$

where ω(t) is angular velocity for the stepper motor 108, and r is the radius of the toothed pulley 114. The angular velocity commands are further converted to PWM signals for the input of the stepper motor driver 126. According to various embodiments, the stepper motor driver 126, stepper motor 108, and encoder 128 attached to the stepper motor 108 form a closed-loop control to execute the PWM signals.

Besides the cosine ground displacement function, in some embodiments the Shakebot 100 also supports ground motion from observed seismograms. As shown, initially a low-pass filter 208 is implemented to remove the high-frequency noise in the raw acceleration data 302 of the seismometer record. Numerical integration computes velocity data 410 from the accelerations. Then a high-pass filter 210 removes the low-frequency noise in the velocity data 410, because the low-frequency noise in velocities may cause accumulated displacement errors. The output of the high-pass filter 210 is a set of translational velocities 406 {v}, which have the same format as the output from the trajectory planner 220. Advantageously, because both the trajectory planner 220 and high-pass filter 210 have the same output format, a velocity controller 216 may be shared to process the desired velocity commands in some embodiments.

In some embodiments, the UI is a portal through which users may conduct shake experiments (e.g., studying PBR overturning responses, etc.). Once initialized, the UI may prompt the user to place a specimen 122 (e.g., a PBR 140, etc.) on the pedestal 106. Then the user needs to input (PGV/PGA, PGA), which is converted to (PGV, PGA). The motion system 202 then executes a single-pulse cosine displacement ground motion based on the (PGV, PGA). After the ground motion is completed, the UI prompts the user to input the result (e.g., the overturn response 224 of the PBR such as being toppled or remaining balanced, etc.). According to various embodiments, the result provided by the user (e.g., overturn response 224), along with ground motion parameters and perception estimates, are saved in a CSV file. Based on the user's input, the UI exits or continues to conduct a new overturning experiment.

Those skilled in the art will recognize that other methods of user interaction and data formats may be used. In some embodiments, additional data may be captured, in some cases automatically. Examples include, but are not limited to, images of the specimen 122 at the start and the end of the experiment, video of the experiment, and the like.

In some embodiments, the subject response status registration may be automated by an object detection system and the subject placement may be implemented by a robotic arm. Automating the shake experiments may result in greater accuracy of subject placement yielding reliable results while requiring less human labor.

According to various embodiments, the contemplated Shakebot 100 needs to be calibrated before conducting the shake experiments. First, the camera intrinsics and fiducial marker detection are calibrated. The calibrated perception system 200 is then used to facilitate velocity controller calibration.

The perception system 200 requires intrinsic camera calibration and fiducial marker detection scaling in some embodiments. The camera calibration ROS package may be used to obtain the intrinsic camera parameters including scale factor, focal length, pixel dimension, and distortion. Despite the intrinsic camera calibration, the translation estimation from apriltag_ros has been found to be inaccurate in some implementation. To calibrate this fiducial marker detection process, a multiplicative factor between the fiducial marker 120 displacement and manually measured displacement may be estimated,

$$D = σ d \qquad ( 9 )$$

where D is the manually measured displacement, σ is the multiplication factor, and d is the displacement from fiducial marker detection.

To better estimate σ, an overdetermined system is used by sampling a number of displacement points along the linear shaft 104 {d},

$$D = σ d \qquad ( 10 )$$

where D=[D₁, D₂, . . . , D_{N}]^{T} is a vector of manually measured displacements, and d=[d₁,d₂, . . . , d_{N}]^{T} is a vector of fiducial marker displacements. The Moore-Penrose inverse is applied to solve the overdetermined system,

$$σ = {{Dd}^{T} [ {dd}^{T} ]}^{- 1} \qquad ( 11 )$$

According to various embodiments, the limit emergency switches 136 at the ends of the linear shafts 104 may be used to facilitate the measurement of pedestal 106 displacement, D. In some embodiments, the Shakebot 100 may have dedicated position calibration switches 138, while in other embodiments the position calibration switches 138 and the limit emergency switches 136 may be the same switches. To begin the perception system 200 calibration, the pedestal 106 moves to the left end until the left pedestal position calibration switch 138 is triggered. At the same time, the fiducial marker detection at this position is recorded. The pedestal 106 then moves to the right end, triggering the right position calibration switch 138, and the fiducial marker detection is recorded again. The manually measured length between the two position calibration switches 138 is then input. During the perception calibration, a position controller that rotates the motor shaft by one angular step given one PWM signal is used. As the pedestal 106 moves from one end to the other, the motor steps are counted and recorded, from which the pedestal displacement per angular step (i.e., translational step resolution) may be calculated. Then, the pedestal 106 randomly moves along the linear shaft 104 to sample data points, such as step counts (e.g., from the left position calibration switch 138) and fiducial marker detections. Using the step counts and translation step resolution, the actual pedestal displacements are calculated. The samples of the actual pedestal displacements and fiducial marker displacements are used in Eq. 11 to estimate σ, according to various embodiments.

The velocity controller calibration aims to reduce the uncertainties from the toothed belt transmission 110. Because of the closed-loop stepper motor 108, it may be assumed that the error between the actual angular velocity and the desired angular velocity of the stepper motor 108 is diminished. Given a desired translational velocity of the pedestal 106, Eq. 8 calculates the corresponding desired angular velocity. However, the toothed pulley 114 radius r is close but not equal to the outside radius of the pulley. The uncertainty in r comes from factors such as the tightness of the toothed belt 112, manufacturing imprecision, and tooth geometry. Such uncertainty is dealt with using a multiplicative factor,

$${ω}^{′} ( t ) = \frac{γ v ( t )}{r} \qquad ( 12 )$$

where γ is a constant that captures the first-order systematic uncertainty in the toothed belt transmission 110. The velocity controller calibration needs to estimate a γ that minimizes the error between the desired and actual translational velocities. Because γ is a factor that calibrates velocity, γv(t) is denoted as calibrated velocity. Instead of directly measuring translational velocity in real time, half-cosine displacement motions (i.e., t∈[0,1/(2f)] in Eqn. 4) may be conducted and y estimated from displacement differences,

D′=γD (13)

where D is the desired half-cosine displacement, and D′ is the actual half-cosine displacement measured from the fiducial marker detection. Similarly, the half-cosine displacement motions may be sampled randomly and the Moore-Penrose inverse used to estimate γ. Using displacement difference to estimate velocity difference has the advantage of easy implementation, because directly measuring translation velocity is challenging.

According to various embodiments, γ estimated from the displacements is the same multiplicative factor for velocity calibration. Based on Eq. 13, there is a calibrated displacement function,

$${D}^{′} ( t ) = γ A - γ A cos ( 2 π f t ) \qquad ( 14 )$$

Note that γ here is estimated from the displacement differences described above. The derivative of D′(t) is taken to obtain the calibrated velocity function,

$${v}^{′} ( t ) = {\dot{D}}^{′} ( t ) = 2 πγ Af sin ( 2 π f t ) \qquad ( 15 )$$

Eq. 7 is substituted into Eq. 15,

$${v}^{′} ( t ) = γ v ( t ) \qquad ( 16 )$$

Therefore, γ estimated from displacements is also the factor that calibrates velocity.

Returning to the specific embodiment described above, the following is a discussion of a specific, non-limiting example of that particular Shakebot 100 being used in a PBR investigation. FIGS. 5A and 5B show the Precariously Balanced Rock (PBR) at the Double Rock site in coastal Central California. Specifically, FIG. 5A shows the Double Rock site, and FIG. 5B shows the extracted PBR used for the following experiment. The yaw orientation in FIG. 5B indicates the relative direction of single-pulse cosine displacement motion.

Experiments were conducted to demonstrate an application of the Shakebot 100 in PBR fragility studies and to test its performance in validating simulation. These experiments focused on a PBR at the Double Rock site in coastal Central California. The PBR, as shown in FIGS. 5A and 5B, was mapped by an unpiloted aerial vehicle and constructed using structure from motion and Poisson reconstruction algorithms.

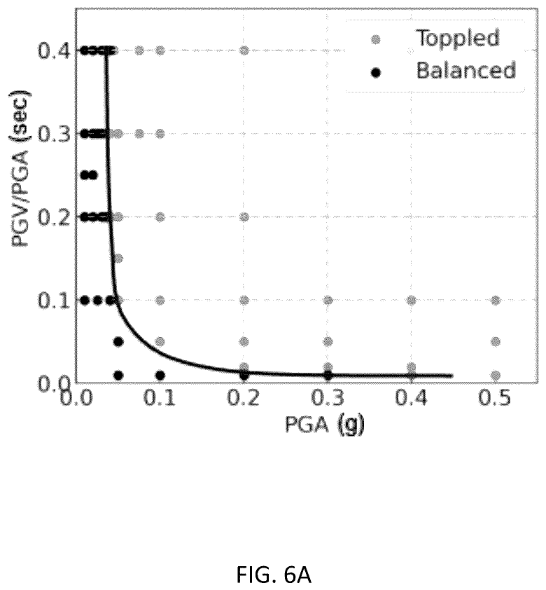

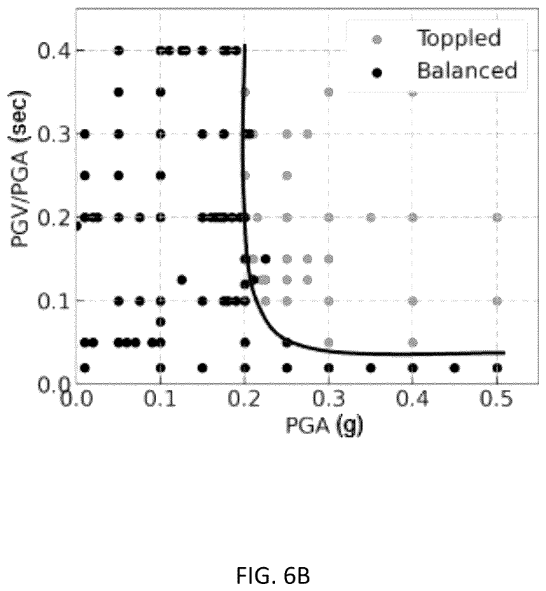

The first experiment demonstrates the Shakebot 100 application in studying the fragility anisotropy of PBRs. The Double Rock PBR was down-scaled from 151.0 cm to 12.0 cm in height and then 3D-printed with PLA material. The resulting model of a precariously balanced rock 140, denoted as 3D-printed PBR (a), had a total mass of 105 g. Because of the asymmetric geometry of 3D-printed PBR (a), the overturning responses were expected to vary with different ground motion directions. To investigate this fragility anisotropy idea, the 3D-printed PBR (a) was placed on the pedestal 106 with two initial orientations: yaw angles of 0° and 270°, as shown in FIG. 5B. Using the UI, the response diagrams was obtained from a set of ground motions, as shown in FIG. 6.

FIGS. 6A and 6B are overturning response diagrams of the Double Rock PBR from orientations of yaw 0° and yaw 270°, respectively, obtained using the specific embodiment of the contemplated Shakebot 100. The grey and black dots represent overturning responses of being toppled and balanced after single-pulse cosine ground motions, respectively. The curves indicate the boundaries of the overturning responses.

The response diagrams indicated that 3D-printed PBR (a) oriented at a yaw angle of 0° was more fragile than at yaw angle of 270°. This result is consistent with previous studies showing that PBRs with smaller minimal contact angles along the motion direction are more fragile. Additionally, the resulting boundary curves closely resembled the simulation results of the Double Rock PBR with original shape.

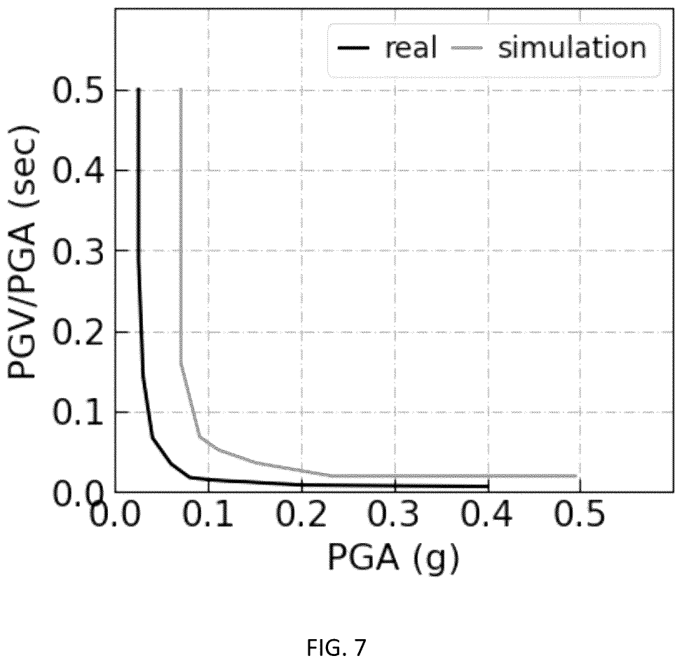

FIG. 7 shows overturning boundary curves obtained from both the contemplated Shakebot 100 and from a virtual shake robot. In the second experiment, the Shakebot 100 was used to evaluate the overturning simulation. The Double Rock PBR was down-scaled to 12.8 cm in height and 3D-printed with the PETG material. The resulting PBR 140, denoted as 3D-printed PBR (b), had a total mass of 404 g. The 3D model of the down-scaled PBR was imported to Gazebo and overturning experiments were conducted using the virtual shake robot. To examine the simulation results, the Shakebot 100 was used to overturn 3D-printed PBR(b). In both simulation and real-world experiments, the PBR had a yaw angle of 0°. As shown in FIG. 7, the overturning boundary curves from the real-world and simulation experiments are similar. According to various embodiments, data from real-world experiments can aid in calibrating and improving the simulation experiment.

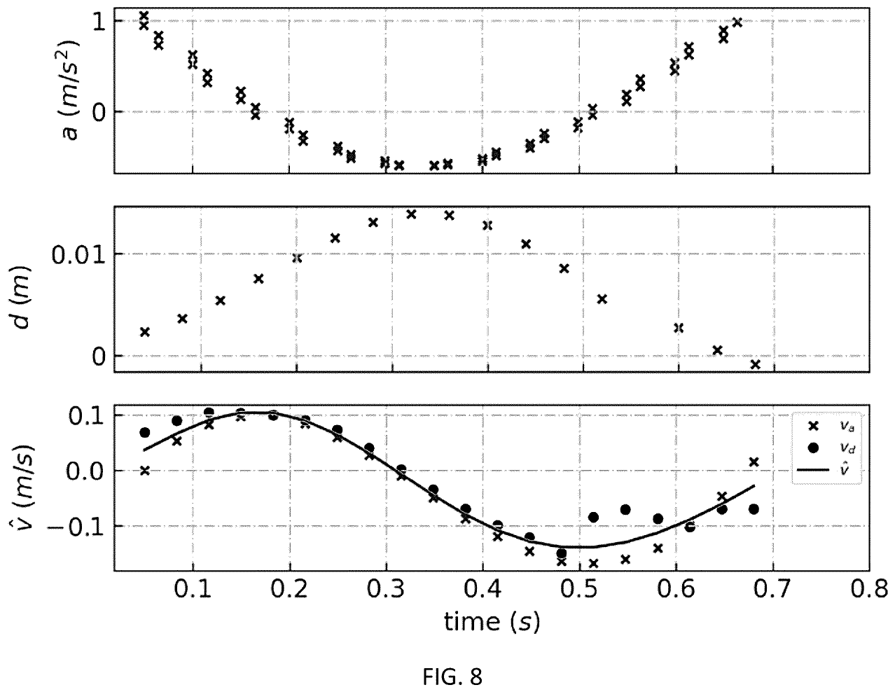

FIG. 8 shows the estimation results of acceleration, displacement, and velocity for the Double Rock PBR, from the input PGA of 0.98 m/s² and PGV/PGA of 0.1 s. According to the PGA and PGV/PGA, the desired PGV and peak ground displacement are 0.1 m/s and 0.01 m, respectively. In this particular example, the velocity estimation method uses the 6th order polynomial function to fuse data from affordable sensors, resulting in a PGV estimate of 0.12 m/s. The resulting velocity estimation is better than individual velocities derived from the accelerometer 118 and fiducial marker detection. In other embodiments, different regression models (e.g., Gaussian process regression, etc.) and real-time state estimation may be used for the ground motion estimation.

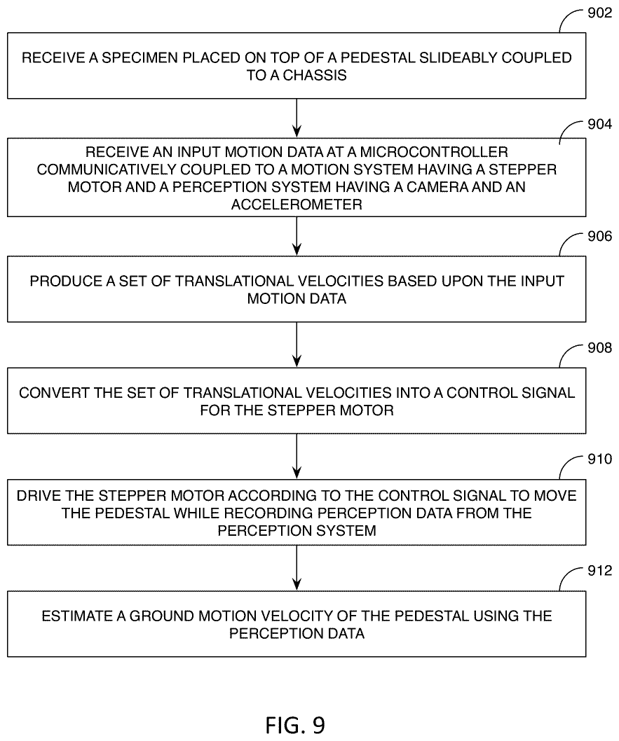

FIG. 9 shows a process flow for a non-limiting example of a method for operating a robotic shake table 100. First, a specimen 122 is received and placed on top of a pedestal slidably coupled to a chassis. See ‘step 902’. According to various embodiments, the pedestal 106 slidably coupled to two linear shafts 104 of a chassis 102.

Next, input motion data 222 is received at a microcontroller 130 communicatively coupled to a motion system 202 and a perception system 200. See ‘step 904’. According to various embodiments, the motion system 202 comprises a stepper motor 108, a transmission 110, and a motor driver 126 communicatively coupled to a stepper motor 108, with the stepper motor 108 coupled to the pedestal 106 through the transmission 110. The stepper motor 108 is also fixedly coupled to the chassis 102. The perception system 200 comprises at least one of an accelerometer 118 coupled to the pedestal 106 and a camera 116 positioned above the pedestal 106 to view a plurality of fiducial markers 120 affixed to the pedestal 106.

From the input motion data 222, a set of translational velocities 406 is produced. See ‘step 906’. The set of translational velocities 406 is converted into a control signal 412 for the stepper motor driver 126. See ‘step 908’.

The stepper motor 108 is then driven according to the control signal 412 to move the pedestal 106 along the two linear shafts 104 while recording perception data 226 from the perception system 200. See ‘step 910’.

Finally, the ground motion velocity 310 of the pedestal 106 is estimated using the perception data 226 obtained from the perception system 200. See ‘step 912’.

It will be understood that implementations and embodiments are not limited to the specific components disclosed herein, as virtually any components consistent with the intended operation of a robotic shake table and methods for using the same may be utilized. Accordingly, for example, although particular components may be disclosed, such components may comprise any shape, size, style, type, model, version, class, grade, measurement, concentration, material, weight, quantity, and/or the like consistent with the intended operation of a robotic shake table may be used. In places where the description above refers to particular embodiments and implementations of a robotic shake table, it should be readily apparent that a number of modifications may be made without departing from the spirit thereof and that these implementations and embodiments may be applied to other shake tables.

What is claimed is:

1. A method for operating a robotic shake table, comprising:
receiving a specimen placed on top of a pedestal, the pedestal slidably coupled to two linear shafts of a chassis;
receiving an input motion data at a microcontroller, the microcontroller communicatively coupled to a motion system and a perception system, wherein the motion system comprises a stepper motor, a transmission, and a motor driver communicatively coupled to a stepper motor, with the stepper motor coupled to the pedestal through the transmission, the stepper motor also fixedly coupled to the chassis and wherein the perception system comprises at least one of an accelerometer coupled to the pedestal and a camera positioned above the pedestal to view a plurality of fiducial markers affixed to the pedestal;
producing a set of translational velocities based upon the input motion data;
converting the set of translational velocities into a control signal for the motor driver;
driving the stepper motor according to the control signal to move the pedestal along the two linear shafts while the specimen is on top of the pedestal and while recording perception data from the perception system; and
estimating a ground motion velocity of the pedestal using the perception data obtained from the perception system.

2. The method of claim 1, wherein the input motion data comprises a peak ground acceleration and a peak ground velocity.

3. The method of claim 2, wherein producing the set of translational velocities based upon the input motion data comprises:
defining a ground velocity function derived from a single-pulse cosine displacement function that comprises the peak ground acceleration and the peak ground velocity; and
producing the set of translational velocities by evaluating the ground velocity function at different times.

4. The method of claim 1, wherein the input motion data comprises a seismometer record having raw acceleration data.

5. The method of claim 4, wherein producing the set of translational velocities based upon the input motion data comprises:
removing high-frequency noise from the raw acceleration data using a low-pass filter;
numerically integrating the raw acceleration data to obtain velocity data;
producing the set of translational velocities by removing low-frequency noise from the velocity data using a high-pass filter.

6. The method of claim 1, wherein estimating the ground motion velocity of the pedestal using the perception data obtained from the perception system comprises at least one of measuring ground motion accelerations of the pedestal using perception data from the accelerometer and estimating ground motion displacements of the pedestal using perception data from the camera observing the plurality of fiducial markers.

7. The method of claim 6,
wherein measuring ground motion accelerations of the pedestal using perception data from the accelerometer comprises:
obtaining raw acceleration data from the accelerometer;
applying a low-pass filter to the raw acceleration data; and
calculating an absolute value of an acceleration vector defined by the raw acceleration data;
wherein estimating the ground motion velocity comprises numerically integrating the ground motion acceleration.

8. The method of claim 6:
wherein estimating ground motion displacements of the pedestal using the perception data from the camera observing the plurality of fiducial markers comprises averaging a relative displacement of each fiducial marker of the plurality of fiducial markers that is visible to the camera; and
wherein estimating the ground motion velocity comprises numerically differentiating the ground motion displacements.

9. The method of claim 6, wherein estimating ground motion velocity of the pedestal comprises combining ground motion velocities estimated using ground motion accelerations obtained using perception data from the accelerometer with ground motion velocities estimated using ground motion displacements estimated using perception data from the camera, forming a combined set of ground motion velocities.

10. The method of claim 9, wherein estimating ground motion velocity of the pedestal further comprises minimizing an error between the combined set of ground motion velocities based on perception data and an estimated velocity function by applying a regression model.

11. The method of claim 10, wherein the estimated velocity function is a polynomial function.

12. The method of claim 9, wherein the ground motion velocities estimated from the ground motion accelerations and the ground motion velocities estimated using the ground motion displacements are asynchronously aligned.

13. The method of claim 1, wherein the perception system further comprises an encoder, and wherein the perception system and the motion system operate together in a closed loop.

14. The method of claim 1, wherein the specimen is a model of a precariously balanced rock.

15. The method of claim 1, further comprising recording an overturn response describing the specimen after the specimen has stopped moving.

16. A robotic shake table comprising:
a chassis comprising two linear shafts and a pedestal slidably coupled to the two linear shafts;
a motion system comprising a stepper motor, a transmission, and a motor driver communicatively coupled to the stepper motor, with the stepper motor coupled to the pedestal through the transmission and the stepper motor also fixedly coupled to the chassis;
a perception system comprising a camera, an accelerometer coupled to the pedestal, and a plurality of fiducial markers coupled to the pedestal; and
a microcontroller communicatively coupled to the motor driver and the perception system, the microcontroller comprising a processor and a memory, the processor configured to:
receive an input motion data;
produce a set of translational velocities based upon the input motion data; and
convert the set of translational velocities into a control signal that will cause the stepper motor to move the pedestal along the two linear shafts according to the set of translational velocities when the control signal is sent to the motor driver.

17. The robotic shake table of claim 16:
wherein the processor is further configured to receive perception data from the perception system;
wherein the perception data comprises raw acceleration data from the accelerometer and relative displacements of fiducial markers observed by the camera; and
wherein the raw acceleration data and the relative displacements are asynchronously aligned.

18. The robotic shake table of claim 16, wherein the perception system further comprises an encoder, and wherein the motion system is a closed loop.

19. The robotic shake table of claim 16:
wherein the input motion data comprises a seismometer record having raw acceleration data; and
wherein the processor produces the set of translational velocities based upon the input motion data by:
removing high-frequency noise from the raw acceleration data using a low-pass filter,
numerically integrating the raw acceleration data to obtain velocity data, and
producing the set of translational velocities by removing low-frequency noise from the velocity data using a high-pass filter.

20. The robotic shake table of claim 16:
wherein the input motion data comprises a peak ground acceleration and a peak ground velocity; and
wherein the processor produces the set of translational velocities based upon the input motion data by:
defining a ground velocity function derived from a single-pulse cosine displacement function that comprises the peak ground acceleration and the peak ground velocity; and
producing the set of translational velocities by evaluating the ground velocity function at different times.
